(19) United States
(12) Patent Application Publication
(10) Pub. No.: US 2025/0277132 A1
(43) Pub. Date: Sep. 4, 2025

(54) POLISH AND SEALANT COMPOSITIONS

(71) Applicant: Energizer Auto, Inc., St. Louis, MO (US)

(72) Inventor: Sarah Springer, Westlake, OH (US)

(73) Assignee: Energizer Auto, Inc., St. Louis, MO (US)

(21) Appl. No.: 19/065,914

(22) Filed: Feb. 27, 2025

Related U.S. Application Data
(60) Provisional application No. 63/559,294, filed on Feb. 29, 2024.

(51) Int. Cl. C09D 183/06; B24B 29/02; C03C 17/30; C03C 19/00; C09G 1/02

(52) U.S. Cl. CPC C09D 183/06; C03C 17/30; C03C 19/00; C09G 1/02; B24B 29/02; C03C 2218/31

(57) ABSTRACT

The present disclosure describes polishing compositions, wherein the polishing compositions include cerium oxide, one or more suspending agents, and water, and optionally one or more preservatives; methods of preparing a polishing composition; and methods of polishing a surface, wherein the methods include applying the polishing compositions to a surface to remove contaminants and scratches. The present disclosure also describes sealant compositions, wherein the sealant compositions include two or more dimethyl siloxanes, and one or more hydrocarbons; methods of preparing a sealant composition; and methods of sealing a surface, wherein the method includes applying the sealant composition to a surface. The present disclosure also describes methods of polishing and sealing a surface, wherein the method includes cleaning and polishing a surface with a polishing composition of the present disclosure and sealing the cleaned and polished surface with a sealant composition of the present disclosure.

### CROSS REFERENCE TO RELATED APPLICATIONS

This application claims the benefit of U.S. Provisional Patent Application 63/559,294, filed on Feb. 29, 2024, which is hereby incorporated by reference in its entirety.

### FIELD OF THE DISCLOSURE

The present disclosure discloses compositions for polishing and repairing hard surfaces including windows, windshields, and mirrors, and compositions for sealing the polished surface to improve repellency to water. The present disclosure also discloses processes for polishing and repairing a hard surface and improving repellency of the surface to water using the compositions described herein.

### BACKGROUND OF THE DISCLOSURE

Vehicle glass, such as front and back windshields, windows, mirrors, sunroofs, and moon roofs, are exposed to many harsh conditions during normal use: weather such as rain sun, hail, and wind; road conditions such as salt and rocks; environmental debris such as dirt, dust, sand, sticks, leaves, pinecones, tree sap, bird droppings, and bugs; and vehicle conditions such as oil, grease, and old or damaged windshield wipers. Many of these conditions cause and/or contribute to the accumulation of damage to glass surfaces in the form of contaminants and fine scratches. For example, a twig, dirt, or sand lodged underneath a windshield wiper during a rain event could create long scratches across the glass surface as the motion of the wiper drags the debris across the glass. Fine scratches in automotive glass presets a safety concern because they can obstruct or distort visibility through the glass, they can contribute to the development of larger scratches, they accumulate contaminants, further reducing visibility, and they reduce water repellency. Despite these problems, fine scratches often do not justify the replacement or repair of windshields by insurance companies, and windshield replacement or professional repair is costly to consumers.

Glass surfaces, such as windows and especially in vehicles typically function to provide visibility to drivers and passengers for safe operation of the vehicle, and also for enjoyment. When glass is new, or in “like new” condition, the visual field is free from obstructions such as scratches, streaks, contaminants, blur, or haze. A “like new” condition provides optimal safety and enjoyment for passengers. For some glass surfaces, such as front and back windshields, devices such as windshield wipers and defoggers may be used to remove accumulated water such as rain, fog, frost, or other condensation. These devices are essential for visibility and safety, but do not operate optimally when glass is scratched or contaminated. The highest level of visibility is achievable only when the glass is smooth and free from contaminants. When water and debris accumulate in scratches, even the best windshield wipers or defoggers may not be able to clear the windshield.

Water repellency formulations may be applied to glass to improve visibility by reducing water's ability to accumulate on the surface. Water “beads” and rolls off of the glass surface because of decreased surface tension and increased hydrophobicity of the glass surface. Water repellency formulas can also improve the function of windshield wipers and defoggers by reducing water's affinity for the glass surface. Water-repellency formulas, such as polysiloxane, nanoparticle, and ceramic glass coatings, are known in the art. These formulas have some deficiencies, however. Sealant setting, performance, and longevity are not optimal when fine scratches are present. These formulas are not specifically formulated to optimally fill fine scratches with clear results.

While sealant formulas for improving water repellency are available, these formulas/products additionally lack a polishing agent and chemical formulation that seal fine scratches. Because of such deficiencies, there is a need for an improved formulation and method for removing and sealing fine scratches and providing an optimized water-repellency formula for glass surfaces, especially automotive glass surfaces. There is also a need for a consumer-friendly kit that provides easy-to-use, step-by-step methods for consumers to effectively remove fine scratches and contaminants from vehicle glass and apply water repellency formulations to achieve an optimal “like new” visibility condition for vehicle glass.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes polishing compositions for polishing and cleaning surfaces. The polishing composition includes an abrasive such as cerium oxide, one or more suspending agents, and one or more solvents. Optionally, the polishing composition includes one or more preservatives. In embodiments, the polishing composition described herein includes deionized water, cerium oxide, carboxymethyl cellulose, and benzisothiazolinone.

The present disclosure also describes solvent-based sealant compositions for sealing a polished and/or cleaned surface to provide improved water repellency. The sealant compositions include two or more dimethyl siloxanes and one or more hydrocarbons. In embodiments, the sealant composition described herein includes dimethyl siloxane with Me silsesquioxanes and n-octyl silsesquioxanes, methoxy-term; dimethyl siloxane, OH-term Rxn methyltrimethoxysilane, and aminoethylaminopropyltrimethoxysilane; C13-C14 isoparaffins; and odorless mineral spirits.

The present disclosure describes methods of preparing the polishing compositions and sealant compositions.

The present disclosure describes methods for using the polishing compositions to polish hard surfaces such as untinted and unpainted glass surfaces. In embodiments, the polishing compositions of the present disclosure can be used on tempered glass that is free from paint, films, or other coatings, for example an exterior surface of a tinted pane of glass.

The present disclosure describes methods of using the sealant compositions to seal polished and/or cleaned hard surfaces including painted and unpainted surfaces. In embodiments, the surface is a tempered glass surface such as a windshield, a sunroof, a moonroof, or a vehicle mirror.

The methods described herein also include polishing the surface using the polishing compositions described herein to polish a surface and subsequently using the sealant compositions to seal the polished surface. The surface can be a glass surface, for example, tempered glass windows and mirrors. The glass surface can be of a vehicle, for example, the windshield, the windows, mirrors, sunroof, and moonroof.

The present disclosure also describes kits including the polishing compositions described herein and sealant compositions described herein for polishing and cleaning glass surfaces of a vehicle.

### BRIEF DESCRIPTION OF THE DRAWINGS

FIGS. 1A and 1B show optical microscopy images of controlled consistent scratches on tempered glass before and after polishing with an exemplary polishing composition of the present disclosure.

FIGS. 2A and 2B show before and after images of the use of exemplary polishing compositions of the present disclosure. FIG. 2A shows images of stuck on contaminates (bugs, syrup) and FIG. 2B shows images of hard water and acid rain before and after use of an exemplary polishing composition of the present disclosure.

FIG. 3 shows contact angle measurements for a car windshield that has been application with an exemplary polishing composition and sealant composition of the present disclosure.

### DETAILED DESCRIPTION

The present disclosure describes methods and compositions for polishing fine scratches and sealing polished surfaces to improve the water-repellency of surfaces. In embodiments, the present disclosure describes polishing compositions and the use of the compositions containing a physical abrasive for removing haze, fine scratches, micro-pitting, mineral deposits, watermarks, and other contaminants from hard surfaces. The compositions and methods described herein can be used on any exterior surfaces free of films or paint including glass such as front and back windshields, windows, mirrors, sunroofs, and moonroofs of a vehicle. For example, the polishing compositions described herein include an abrasive such as cerium oxide. In an exemplary method of using the polishing composition, a polishing composition described herein can be applied to the surface to polish and clean the surface by removing small layers of glass and removing stuck-on and/or baked-on contaminates. Moreover, the polished surface and loosened debris can be cleaned off with a simple rinse. Thus, the polishing compositions described herein are also able to clean and/or repair surfaces, for example to restore clarity to a glass surface.

In embodiments, the present disclosure also describes sealant compositions and the use of such compositions to seal polished and clean surfaces and improve the water repellency of such surfaces. The sealant compositions are solvent-based compositions including one or more moisture-curing polysiloxane resins and one or more additives. In an exemplary method of using the solvent-based sealant composition, the solvent-based sealant composition is applied to a polished and/or cleaned surface. When the solvent-based sealant is applied to the surface as directed, water repellency is greatly increased compared to untreated glass. Application of the sealant compositions of the present disclosure also provides protection to repel contaminants such as water stains, road grime, and oxidation. Thus, applying the sealant composition as a coating to the surface improves visibility and smooths the surface by helping to remove fine scratches and repel water for months. The sealant composition also assists in minimizing fine scratches by filling in said scratches. The sealant composition also increases the hardness of the surface, adding slight improvement to abrasion resistance.

In embodiments, a surface can be first polished and/or cleaned with a polishing composition described herein and then sealed with a sealant composition described herein.

The present disclosure also describes a repair and water-repellency kit. In embodiments, the kit includes a polishing composition that removes fine scratches and stuck-on debris, and a solvent-based sealant composition that seals the polished surface. Applying the coating to the surface improves visibility and smooths glass by helping to remove fine scratches and repel water for at least 12 months and up to 24 months.

The compositions described herein provide professional results for removing fine scratches from a surface, such as a glass surface free of films or paint, and provide water repellency, in a simple easy-to-use process. In embodiments, the present disclosure describes a simple three-step process that takes less than 15 minutes to complete. In embodiments, the present disclosure describes a method for restoring a surface to its original condition: by stripping away layers of coatings, road film, and contaminants such as bugs, bird droppings, and salt; by removing watermarks, newly formed or baked-on hard water mineral deposits, fine scratches, micro-pitting, and windshield wiper marks; and by removing yellowing due to hazing. The removal of contaminants and hazing may improve visibility by 100% or more on rainy nights, adding valuable time to driver response time. For example, at 60 mph, this visibility improvement provides an extra 88 feet of pavement to avoid a potential accident.

In embodiments, the compositions and methods described herein protect surfaces such as a glass free of films or paint, by providing a streak-free, residue-free, hydrophobic, ceramic protective sealant layer that minimizes UV rays and makes future contaminants, such as bird droppings, tree sap, and environmental contaminants much easier to remove. In embodiments, the compositions and methods provide exceptional durability, protection, and water repellency for at least 12 months, such as up to 24 months. The compositions and methods described herein can be used on any exterior surfaces free of films or paint including glass such as front and back windshields, windows, mirrors, sunroofs, and moonroofs of a vehicle.

The present disclosure describes polishing compositions including components that interact to form a useful polish and repair composition. The components of the compositions include water, cerium oxide, and one or more suspending agents, and optionally one or more preservatives. The water can be deionized (DI) water.

The cerium oxide of the polishing compositions described herein is in powdered form. The cerium oxide has a particle size of about 1 to 20 microns, about 5 to 17 microns, about 5 to 15 microns, or about 5 to 10 microns. The purity of the cerium oxide is in the range of about 94.00% to 100%, about 95.00% to 100%, about 96.00% to 100%, about 97.00% to 100%, about 98.00% to 100%, about 99.00% to 100%, about 99.5%, or about 99.99%.

The one or more suspending agents of the polishing compositions described herein include: one or more methyl celluloses, such as carboxymethyl cellulose (e.g., Carboxymethyl Cellulose Sodium Salt (n=approx. 500)), hydroxypropyl methyl cellulose; one or more modified acrylic polymers, such as Carbopol® EZ-3); and one or more acrylic copolymers, such as a hydrophobically-modified alkali soluble emulsion (HASE) polymer (e.g., NOVETHIX™ L-10).

The one or more preservatives in the formulations can include hydantoin germicide, carbamate fungicide, benzisothiazolinone (BIT), methylisothiazolinone (MIT), and/or methylchloroisothiazolinone (CMIT). In embodiment, the one or more preservatives can include a combination of BIT, MIT, and CMIT. For example, the one or more preservatives can include TROYGUARD BC11.

The polishing compositions described herein include by total weight of the composition:
about 85.0% to 95.0%, about 87% to 94%, about 89% to 93%, about 90% to 93%, about 91% to 93%, about 91% to 92%, or about 91.9% water;
about 0.5% to 7.0%, about 1.0% to 6.5%, about 2.0% to 6.0%, about 3.0% to 5.5%, or about 5.0% cerium oxide, and optionally wherein the cerium oxide has a particle size of about 1 to 20 microns; and
about 0.5% to 5.0%, about 1.0% to 4.5%, about 1.00% to 4.00%, about 2.00% to 3.50%, or about 3.0% of one or more suspending agents; and
optionally about 0.05% to 0.50%, about 0.08% to 0.250%, about 0.09% to 0.20%, or about 0.10% of one or more preservatives.

In embodiments, the polishing composition described herein includes deionized water, cerium oxide, carboxymethyl cellulose, and benzisothiazolinone. In embodiments, the polishing composition includes by total weight of the composition:
about 91.9% deionized water;
about 5.0% cerium oxide or cerium oxide having a particle size of about 5 to 10 microns and a purity of 99.99% or greater;
about 3.0% carboxymethyl cellulose or carboxymethyl cellulose sodium salt (n=approx. 500); and
about 0.1% benzisothiazolinone or TROYGUARD™ BC11.

The present disclosure describes a method of preparing the polishing compositions described herein wherein the method includes combining the components sequentially and constantly mixing the composition while the components are added. In embodiments, the components of the composition are added in the following order: water, one or more suspending agents, and cerium oxide. In embodiments, one or more preservatives can also be added to the composition, and the one or more preservatives can be added after the water. In embodiments, the components are added sequentially to a container and mixed.

The method of preparing the polishing composition can also include dispensing the prepared composition in a container. The container can be a bottle, and optionally a spray bottle.

The present disclosure describes methods of polishing and/or repairing a surface. In embodiments, the polishing and sealing compositions of the present disclosure may be applied in a controlled environment, such as under an awning or inside a building or garage, to protect the application site from environmental conditions that may disrupt appropriate application.

The methods include applying a polishing composition described herein to the surface to remove contaminants and scratches. Applying the polishing composition includes wiping the composition to cover the entire surface to clean and polish it. In embodiments, the polishing composition can be applied to the surface using an applicator that can wipe the surface to clean and polish it. The applicator can be a mechanical device, a sponge, a cloth, a paper towel, or a combination thereof. The method can also include a rinsing step to rinse off the contaminants and residues.

In embodiments, a method for applying the polishing compositions of the present disclosure to a surface includes: preparing the surface by removing items such as windshield wipers and large debris such as leaves from the surface; and preparing the polishing composition by mixing the composition before use, such as by shaking the bottle or container containing the composition. Next, with an applicator in hand, the polishing composition can be applied to either the applicator or directly to the surface, and then with the applicator, the surface can be polished by wiping the polishing composition in circular motions on the surface to remove stuck on contaminants and debris. For optimal results, the whole surface should be polished, and polishing can be repeated on any areas of the surface that may still have scratches and stuck on debris. After polishing, the surface should be rinsed thoroughly with water to remove all polish and contaminants, and then dried completely, such as by using an air dryer and/or a clean dry towel, prior to applying the sealant composition. In embodiments, the surface may be cleaned prior to application of the sealant compositions with a cleaner, such as an auto glass cleaner, that does not leave behind any residue or coating.

In embodiments, the sealant composition may be applied sparingly to the fully dry surface starting at a first end of the surface, such as at the top of the surface. With a clean applicator and beginning at the first end of the surface, the sealant can be spread evenly in long, sweeping motions horizontally across the surface. When applying the sealant to a surface, the sealant can be applied in sections. For example, if the surface is a large surface such as a windshield, the sealant can be applied completely to a first half of the windshield and then to a second half of the windshield. Application areas may be further divided or expanded based on user preference and/or the size of the surface.

During application of the sealant compositions, the surface may look textured and cloudy as the composition starts to cure. After 10 minutes, the surface may not be completely dry, but may be buffed to a smooth clear finish using a clean dry towel, such as a microfiber towel. After buffing, the sealant should be allowed to cure fully, for example for 90 minutes. Before the sealant is fully cured, the surface should not be exposed to water or significantly disturbed, such as with windshield wipers. If any cloudy spots appear on the surface during curing, the cloudy area may be buffed with a clean dry cloth, such as a microfiber towel.

The polishing composition can be used on glass surface that is not coated with a film. The glass surface can be untinted or tinted exterior surface. The glass surface can be mirrors and windows including skylights (roof windows). In embodiments, the glass surface can be of a vehicle, for example, a windshield, a window, a sunroof, a moonroof, an exterior glass, an interior mirror, and an exterior mirror.

In embodiments, it is the combination of the components such as cerium oxide with the one or more suspending agents and water that interact together to provide an effective polishing and cleaning agent.

The present disclosure also describes sealant compositions including components that interact to seal a cleaned and/or polished surface and provide water repellency to it. The sealant compositions include two or more dimethyl siloxanes and one or more hydrocarbons.

The two or more dimethyl siloxanes of the sealant compositions described herein include at least one or more alkoxy siloxane resins and at least one or more dimethyl siloxane fluids. The one or more alkoxy siloxane resins include a solvent-less methoxy functional liquid siloxane. In embodiments, the one or more alkoxy siloxane resins include dimethyl siloxane with Me silsesquioxanes and n-octyl silsesquioxanes, methoxy-term (e.g., DOWSIL™ 2405 Resin). In embodiments, the one or more dimethyl siloxane fluids include dimethyl siloxane, OH-term Rxn methyltrimethoxysilane, and aminoethylaminopropyltrimethoxysilane (e.g., XIAMETER™ OFX-0536 Fluid).

The one or more hydrocarbons of the sealant compositions described herein include isoparaffins and mineral spirits. The isoparaffins include C13-C14 isoparaffins (e.g., ISOPAR™ M Fluid). The mineral spirits include odorless mineral spirits. In embodiments, the sealant compositions include two or more hydrocarbons. The two or more hydrocarbons include C13-C14 isoparaffins and odorless mineral spirit.

The sealant compositions described herein include by total weight of the composition:
about 30.0% to 50.0%, about 32.0% to 45.0%, about 33.0. % to 40.0%, about 34.0% to 35.5%, or about 35.0% of one or more alkoxy siloxane resins;
about 1.0% to 10.0%, about 2.00% to 8.00%, about 4.00% to 6.00%, or about 5.0% of one or more dimethyl siloxane fluids;
about 30.0% to 50.0%, about 33.0% to 47.0%, about 35.0. % to 45.0%, about 38.0% to 42.0%, or about 40.0% of one or more isoparaffins; and
about 10.0% to 30.0%, about 12.0% to 28.0%, about 15.0. % to 25.0%, about 18.0% to 22.0%, or about 20.0% of one or more mineral spirits.

The sealant compositions described herein include dimethyl siloxane with Me silsesquioxanes and n-octyl silsesquioxanes, methoxy-term; dimethyl siloxane, OH-term Rxn methyltrimethoxysilane, and aminoethylaminopropyltrimethoxysilane; C13-C14 isoparaffins; and odorless mineral spirits.

The sealant composition described herein includes by total weight of the composition:
about 35.0% alkoxy siloxane resin or DOWSIL™ 2405 Resin;
about 5.0% dimethyl siloxane fluid or XIAMETER™ OFX-0536 Fluid;
about 40.0% C13-C14 isoparaffin or ISOPAR™ M Fluid; and
about 20% odorless mineral spirit or Klean Strip Odorless Mineral Spirits.

In embodiments, each of the components of the compositions described herein can be a mixture including the main ingredient and one or more other ingredients. The other ingredients can include water, impurities, and ingredients that are below reportable levels. For example, TROYGUARD™ BC11, an example of benzisothiazolinone, can include benzisothiazol-3(2h)-one as the main ingredient, and 5-chloro-2-methyl-4-isothiazolin-3-one, and 2-methyl-2H-isothiazol-3-one. DOWSIL™ 2405 Resin, an example of can include alkoxy siloxane resin, can include dimethyl siloxane with Me silsesquioxanes and n-octyl silsesquioxanes, methoxy-term; and methanol. XIAMETER™ OFX-0536 Fluid, an example of dimethyl siloxane fluid, can include dimethyl siloxane, OH-term Rxn methyltrimethoxysilane, and aminoethylaminopropyltrimethoxysilane; methanol; decamethylcyclopentasiloxane; and octamethylcyclotetrasiloxane. The ISOPAR™ M Fluid, an example of isoparaffin, can include hydrotreated light distillates (petroleum). Klean Strip Odorless Spirits, an example of an odorless spirit, can include hydrotreated light distillate (petroleum, mineral spirits). CARBOPOL® EZ-3 polymer, an exemplary modified acrylic polymer, can include modified acrylic polymer, alcohol ethoxylate, and cyclohexane.

The present disclosure describes methods of preparing the sealant compositions described herein, wherein the method includes combining all the components and then mixing the components. The components include two or more dimethyl siloxanes, wherein there are at least one or more alkoxy siloxane resins and at least one or more dimethyl siloxane fluids; and one or more hydrocarbons; and mixing the composition. The components can be combined sequentially or all at the same time and then mixed. The methods of preparing the sealant compositions described herein also include combining and mixing the components, wherein the components can be added sequentially with constant mixing after each addition or added all at the same time and mixed.

The present disclosure describes methods of using the sealant compositions to seal polished, cleaned, and/or repaired surfaces. The methods include applying the sealant composition to the surface. Applying the sealant composition includes any method of contacting the surface with the sealant composition including using an applicator. The applicator can be a suede block or a sponge such as a microfiber or polyurethane sponge.

The surface can be any hard surface that has been cleaned or polished. It can be a painted or unpainted surface. The surface can be a glass surface. Examples of glass surfaces include windows including skylights, windshields, and mirrors. The glass surface can be an exterior surface or an interior surface. In embodiments, the surface is that of a vehicle, such as a windshield, a window, a sunroof, a moonroof, an exterior glass, an interior mirror, and an exterior mirror.

Examples of vehicles include automobiles, buses, trains, watercrafts including ships and boats, aircrafts including planes and helicopters, and spacecrafts.

In embodiments, the methods of polishing and sealing a surface described herein include polishing and/or cleaning a surface using a polishing composition described herein and then sealing the polished and/or cleaned surface with a sealant composition described herein.

In embodiments, the methods of using the polishing compositions and sealant compositions can be performed on separate surfaces. The methods of using the polishing compositions do not need to be followed by the method of using the sealant composition described herein. Similarly, the methods of sealing cleaned surfaces using the sealant compositions do not need to be preceded by a method of using the polishing composition described herein.

The present disclosure also describes a kit for polishing a surface including a polishing composition described herein and one or more applicators for applying the polishing composition. The applicator can be a mechanical device. The kit can also include instructions for using the polishing composition.

The present disclosure also describes a kit for sealing a cleaned surface including a sealant composition described herein and one or more applicators for applying the sealant composition. The applicator can be a polyurethane sponge. The kit can also include instructions for using the sealant composition.

The present disclosure also describes a kit for polishing and sealing a surface including a polishing composition described herein and a sealant composition described herein. The kit can include one or more applicators for applying the compositions to the surface. The kit can include a mechanical device for polishing the surface and/or a polyurethane sponge for sealing the cleaned surface. The kit can also include instructions for using the polishing composition and sealing composition.

In embodiments, it is the interactions of the one or more dimethyl siloxanes and the one or more hydrocarbons that enable the sealant composition to seal the cleaned surface and provide water repellency. The interactions of the components can be synergistic, especially the interactions of the dimethyl siloxanes.

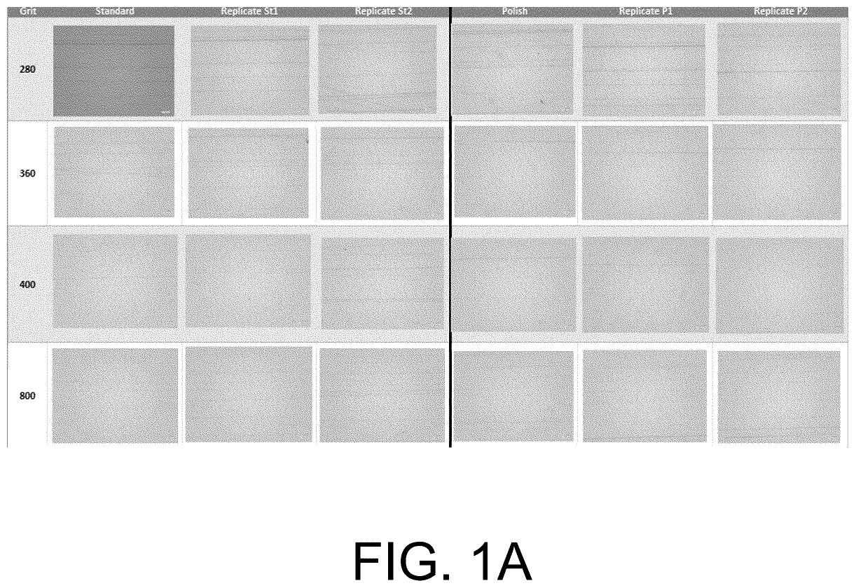

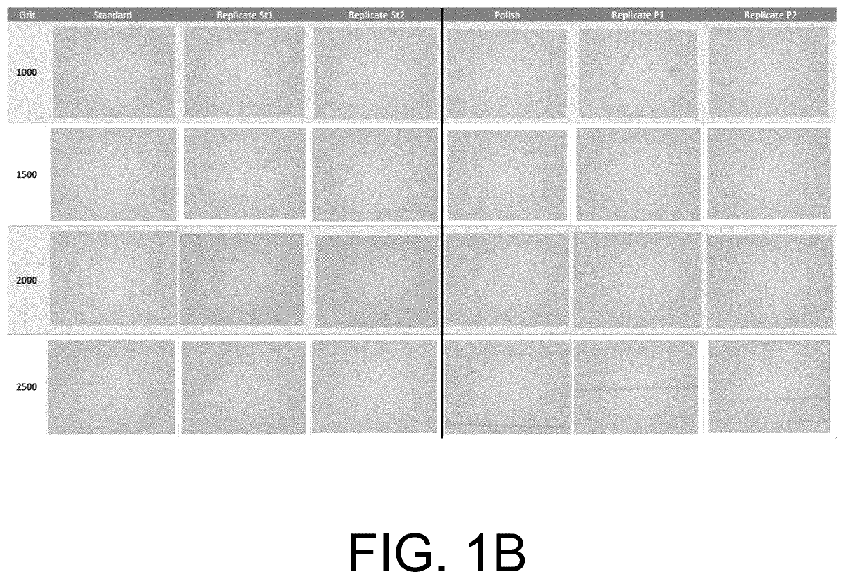

In embodiments, the polishing compositions described herein remove fine scratches and stuck-on debris, and the solvent-based sealant compositions described herein seal the polished surface. In embodiments, polishing compositions of the present disclosure can restore glass clarity by stripping away layers of haze, coatings, grime, and contaminants, remove water marks, newly formed or baked-hard water mineral deposits, fine scratches, micro-pitting, and windshield wiper marks. For example, FIG. 1 shows after polishing with an exemplary polishing composition of the present disclosure, scratches are less severe for high grit sandpaper. FIG. 1A shows optical microscopy images of controlled consistent scratches on tempered glass for scratches made from 280-800 grit sandpaper, and FIG. 1B shows optical microscopy images of controlled consistent scratches on tempered glass for scratches made from 1000-2500 grit sandpaper. Scratches were made on the tempered glass surfaces using a standardized abrasion test (TQC Abrasion machine). The left three columns in FIGS. 1A and 1B show three separate trials (Standard, Replicate St1, and Replicate St2) of scratches made at each grit on the tempered glass. The right three columns in FIGS. 1A and 1B show three separate trials (Polish, Replicate P1, and Replicate P2) of polish applied to the tempered glass that received scratches at each grit.

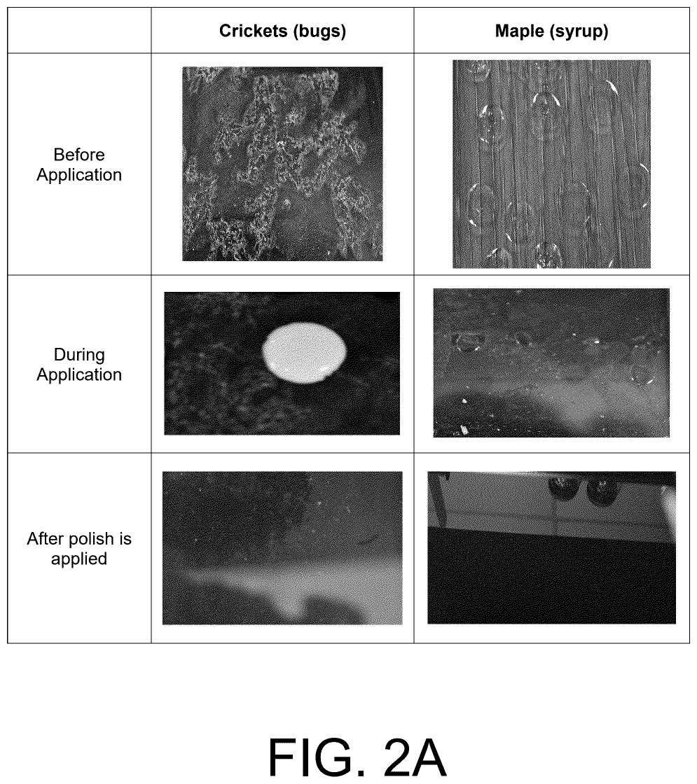

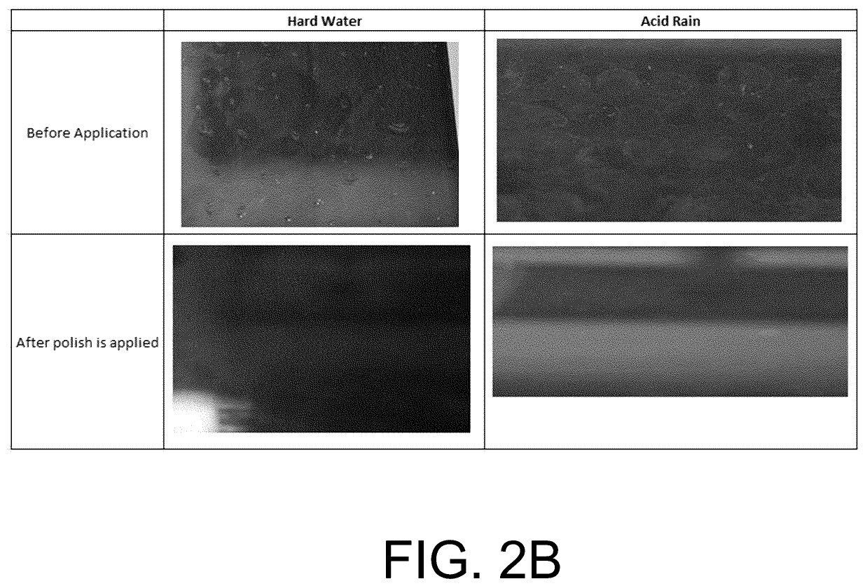

FIG. 2 shows examples of stuck on contaminates, bugs, syrup (FIG. 2A) and hard water and acidic water (FIG. 2B), before and after use of an exemplary polishing composition of the present disclosure. The contaminants of FIG. 2A, bugs and syrup, were placed on a clean dry tempered glass panel. Glass panels were placed at 85° C. for 24 hours. After 24 hours, panels were removed and cooled to room temperature. Once cooled, polishing compound was applied and the glass polished. Polishing compound was rinsed with water and photos taken to show removal.

For the tests shown in FIG. 2B, the hard water solution was prepared using calcium and magnesium carbonates, drops were placed on a clean dry tempered glass panel. Acid rain is rain or any other form of precipitation that is unusually acidic, or having low pH, e.g., from about 4-5. To test acid rain, the pH of tap water was measured and adjusted to approximately 4-5, drops were placed on a clean dry tempered glass panel. Glass panels were placed in an 85° C. for 24 hours. After 24 hours, panels were removed and cooled to room temperature. Once cool, polishing compound was applied and the glass polished. Polishing compound was rinsed with water and photos taken to show removal.

Applying the polishing and sealant compositions of the present disclosure to a windshield can improve visibility by about 50% to 200%. In embodiments, the compositions described herein can improve visibility by about 50% to 200%, 75% to 175%, 100% to 175%, 75% to 125%, 150% to 170%, 160%, or about 100%. For example, the percentage improvement in visibility for a car windscreen was calculated from an initial visual quality score (VQS) through the car windscreen with no product applied, and a final VQS after an exemplary polishing composition and sealant composition of the present disclosure were applied to the windscreen, see Table 1. The windscreen was cleaned on the interior and exterior surfaces and the exemplary polishing composition was applied to the entire exterior surface of the windscreen, and polished with a sponge according to methods described herein. The polishing composition was then washed from the surface of the windscreen and the windscreen was allowed to dry. An exemplary sealant composition of the present disclosure was then applied to the exterior surface of the windscreen and allowed to cure for 10 minutes then buffed, according to methods described herein. A microfiber towel was used to buff and wipe the sealant composition. After about 90 minutes, a second layer of the sealant composition was applied to the exterior surface according to the same method and wiped with a microfiber towel. The sealant was then left without disruption overnight and the VQS measurements were taken the following morning.

VQS measurements were taken with a VisiNex™ system, and the VQS number represents a comfort of visibility and easiness of object detection. The experimental condition included applying simulated heavy rain (HR) to the windscreen with low wiping speed (W1) of the windshield wipers. Within this condition, two tests were conducted, one with stray light directed at the windscreen (Light) and one without (No Light). The % improvement score was calculated using the following the calculation:

$$\% improvement = \frac{Final VQS - Initial VQS}{Initial VQS} \times 100$$

TABLE 1
% improvement in Visual Quality Score - Heavy Rain

| | No prod | | Product | | | |
|---|---|---|---|---|---|---|
| | Mean | | Mean | | | % |
| Measurement | VQS % | Nb | VQS % | Nb2 | Delta | Improvement |
| Light | | | | | | |
| HR W1 | 26.4 | 1 | 53.9 | 3 | 27.50% | 104.17 |
| No Light | | | | | | |
| HR W1 | 32.7 | 1 | 86.3 | 3 | 53.60% | 163.91 |

*HR (Heavy rain = Big Drops),
W1 (Low wiping speed)

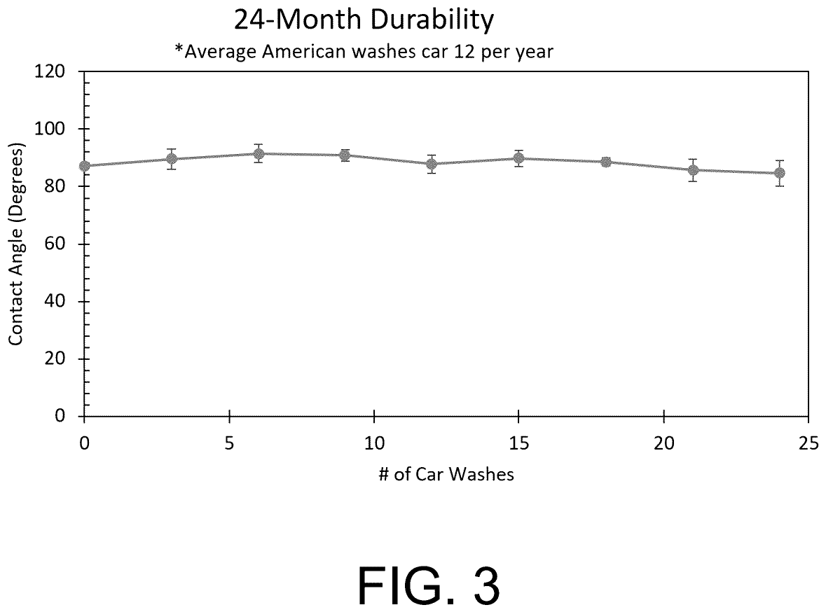

In embodiments, the polishing and sealant compositions when used sequentially can repel water for at least 12 months, such as up to 24 months. In an experimental example, it was shown that the contact angle (water repellency) of tempered glass increased, for example from 36.85° to 76.76°, after application of polishing and sealant compositions of the present disclosure. FIG. 3 shows contact angle measurement for a car windshield that has been applied with an exemplary polishing composition and sealant composition of the present disclosure. An initial measurement was taken after application of the polishing and sealant compositions (wash 0), and subsequent measurements were taken after each of 24 car washes. FIG. 3 shows that the contact angle measurement remains steady after each of the 24 washes. The 24-month durability of the polishing and sealant compositions is related to the 24 car washes shown in FIG. 3 at the American average of 12 car washes per year (12 months), therefore the results after 24 washes also represents results after 24 months. For example, water repellency is durable for at least about 24 washes. for about 6 to 24 months, about 8 to 20 months, about 10 to 18 months, about 12 to 16 months, about 12 to 14 months, about 10 to 24 months, about 14 to 24 months, or about 18 to 24 months.

In embodiments, the compositions described herein, the kits described herein including both the polishing and sealant compositions, or the use of both the polishing and sealant compositions, can improve clarity and provide a streak-free, residue-free coating of protection to a car windshield. Table 2 shows product testing results.

TABLE 2
Functional Performance - Consumer Testing

| | Very | |
|---|---|---|
| | Satisfied & | |
| | Somewhat | Very |
| | Satisfied | Satisfied |
| Glass clarity after kit is fully applied | 97% | 93% |
| Evenness of application | 96% | 93% |
| Daytime clarity | 93% | 93% |
| Nighttime clarity | 96% | 89% |
| Ease of application | 100% | 86% |
| Product consistency | 96% | 82% |
| Control of application | 93% | 82% |
| Necessary time to apply the product | 90% | 79% |

Table 3 shows the % improvement in visibility through a car windscreen calculated from an initial visual quality score (VQS) through the car windscreen with no product applied, and a final VQS after an exemplary polishing composition and sealant composition of the present disclosure were applied to the windscreen. The compositions were applied and VQS measurements were taken as described above for data shown in Table 1. The experimental condition of Table 3 was a dry windscreen with no rain, and no wiping of the windshield wipers. Within this condition, two test were conducted, one with stray light directed at the windscreen (Light) and one without (No Light).

TABLE 3
% improvement in Visual Quality Score - No Rain

| | No prod | | Product | | | |
|---|---|---|---|---|---|---|
| | Mean | | Mean | | | % |
| Measurement | VQS % | Nb | VQS % | Nb2 | Delta | Improvement |
| Light | | | | | | |
| NoR | 93.5 | 3 | 95.5 | 3 | 2.0% | 2.14 |
| No Light | | | | | | |
| NoR | 97.7 | 3 | 98.9 | 3 | 1.2% | 1.23 |

*NoR (No Rain)

In embodiments, polishing and sealant compositions of the present disclosure adds chemical resistance to a surface from rock chips, tree sap, bird dropping and road grime for enhanced glass protection and easy clean up. For example, the ceramic/silicone coating, such as the dimethyl siloxane found in DOWSIL 2405 and XIAMETER OFX-0563, provides abrasion resistance and protection of metal, wood, and glass. An exemplary Moh's hardness test determined that tempered glass was rated as 4-5 on the Moh's hardness scale.

Glass treated with an exemplary polish and sealant composition of the present disclosure was rated between 5-6 Moh's hardness scale. A higher value on the Moh's hardness scale indicates if a surface is harder than another suggesting better resistance to abrasion.

The compositions described herein provide professional results for removing fine scratches from a surface, such as a glass surface free of films and paint, and provide water repellency, in a simple easy-to-use process. In embodiments, the present disclosure describes a simple three-step process that takes less than 15 minutes to complete. In embodiments, the present disclosure describes a method for restoring a surface to its original condition by stripping away layers of coatings, road film, and contaminants such as bugs, bird droppings, salt, removing watermarks, newly formed or baked-on hard water mineral deposits, and removing fine scratches, micro-pitting and windshield wiper marks, and removing yellowing due to hazing. The removal of hazing may improve visibility by about 100% or more on rainy nights, adding valuable time to driver response time. For example, at 60 mph, this visibility improvement provides an extra 88 feet of pavement to avoid a potential accident. In embodiments, the compositions and methods described herein protect surfaces such as glass free of films and paint, by providing a streak-free, residue-free, hydrophobic, ceramic protective sealant layer that minimizes UV rays and makes future contaminants, such as bird droppings, tree sap, and environmental contaminants much easier to remove. In embodiments, the compositions and methods provide exceptional durability, protection, and water repellency for at least 12 months, such as up to 24 months. The compositions and methods described herein can be used on any interior and exterior surfaces free of films and paint, including glass such as front and back windshields, windows, mirrors, sunroofs, and moonroofs of a vehicle. In embodiments, the compositions described herein are used on the exterior of a vehicle.

The terms “composition(s)” and “formulation(s)” are used interchangeably to refer to the compositions described herein.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition for polishing or sealing a surface.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

It is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

The Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are exemplary embodiments:

1. A polishing composition, wherein the polishing composition comprises cerium oxide, one or more suspending agents, and water, and optionally one or more preservatives.

2. The polishing composition of embodiment 1, wherein the cerium oxide is in powdered form, and optionally the cerium oxide has a particle size of 1 to 20 microns and/or a purity of about 95% to 100%.

3. The polishing composition of embodiment 1 or 2, wherein the one or more suspending agents comprise carboxymethyl cellulose, hydroxypropyl methyl cellulose, a modified acrylic polymer, an acrylic copolymer, or a combination thereof.

4. The polishing composition of any one of embodiments 1-3, wherein the one or more preservatives comprise hydantoin germicide, carbamate fungicide, benzisothiazolinone (BIT), methylisothiazolinone (MIT), and/or methylchloroisothiazolinone (CMIT); and optionally the one or more preservatives comprise a combination of BIT, MIT, and CMIT.

5. The polishing composition of any one of embodiments 1-4, wherein the polishing composition comprises by total weight of the composition:
about 85.0% to 95.0% water;
about 0.5% to 5% cerium oxide; and
about 0.5% to 5% of one or more suspending agents; and
optionally about 0.05% to 0.50% of one or more preservatives.

6. The polishing composition of any one of embodiments 1-5, wherein the polishing composition comprises cerium oxide, carboxymethyl cellulose, benzisothiazolinone, and deionized water.

7. The polishing composition of any one of embodiments 1-6, wherein the polishing composition comprises by total weight of the composition:
about 91.9% deionized water;
about 5% cerium oxide having a particle size of 5 to 10 microns;
about 3.0% carboxymethyl cellulose; and
about 0.10% benzisothiazolinone.

8. A method of preparing the composition of any one of embodiments 1-7, wherein the method comprises combining sequentially with constant mixing: water, one or more suspending agents, and cerium oxide; and optionally wherein one or more preservatives are added to the water before the one or more suspending agents.

9. A method of polishing a surface, wherein the method comprises applying the polishing composition of any one of embodiments 1-8 to a surface to remove contaminants and scratches.

10. The method of embodiment 9, wherein the surface is a glass surface that is not coated.

11. The method of embodiment 9 or 10, wherein the surface is the surface of a vehicle, and optionally the surface comprises a windshield, a window, an exterior glass, an interior mirror, and an exterior mirror.

12. The method of any one of embodiments 9-11, wherein the method further comprises applying the polishing composition to an applicator and using the applicator to apply the polishing composition to the surface; and optionally wherein the applicator is a mechanical device.

13. A sealant composition, wherein the sealant composition comprises:
two or more dimethyl siloxanes, wherein the two or more dimethyl siloxanes comprise one or more alkoxy siloxane resins and one or more dimethyl siloxane fluids; and one or more hydrocarbons.

14. The sealant composition of embodiment 13, wherein the one or more alkoxy siloxane resins comprise a solvent-less methoxy functional liquid siloxane, and optionally wherein the one or more alkoxy siloxane resins comprise dimethyl siloxane with Me silsesquioxanes and n-octyl silsesquioxanes, methoxy-term.

15. The sealant composition of embodiment 13 or 14, wherein the one or more dimethyl siloxane fluids comprise dimethyl siloxane, OH-term Rxn methyltrimethoxysilane, and aminoethylaminopropyltrimethoxysilane.

16. The sealant composition of any one of embodiments 13-15, wherein the one or more hydrocarbons comprise isoparaffins and mineral spirits.

17. The sealant composition of any one of embodiments 13-16, wherein the one or more hydrocarbons comprise C13-C14 isoparaffins and odorless mineral spirits.

18. The sealant composition of any one of embodiments 13-17, wherein the sealant composition comprises by total weight of the composition:
about 30.0% to 50.0% of one or more alkoxy siloxane resins;
about 1.0% to 10.0% of one or more dimethyl siloxane fluids;
about 30.0% to 50.0% of one or more isoparaffins; and
about 10.0% to 30.0% of one or more mineral spirits.

19. The sealant composition of any one of embodiments 13-18, wherein the sealant composition comprises dimethyl siloxane with Me silsesquioxanes and n-octyl silsesquioxanes, methoxy-term; dimethyl siloxane, OH-term Rxn methyltrimethoxysilane and aminoethylaminopropyltrimethoxysilane; C13-C14 isoparaffins; and odorless mineral spirit.

20. The sealant composition of any one of embodiments 13-19, wherein the sealant composition comprises by total weight of the composition:
about 35.0% dimethyl siloxane with Me silsesquioxanes and n-octyl silsesquioxanes, methoxy-term;
about 5.0% dimethyl siloxane, OH-term Rxn methyltrimethoxysilane and aminoethylaminopropyltrimethoxysilane;
about 40.0% C13-C14 isoparaffins; and
about 20% odorless mineral spirit.

21. A method of preparing the composition of any one of embodiments 13-20, wherein the method comprises:
combining two or more dimethyl siloxanes, wherein the two or more dimethyl siloxanes comprise one or more alkoxy siloxane resins and one or more dimethyl siloxane fluids; and
one or more hydrocarbons; and
mixing the composition.

22. A method of sealing a surface, wherein the method comprises applying the sealant composition of any one of embodiments 13-20 to a surface.

23. The method of embodiment 22, wherein the surface has been polished and/or cleaned before applying the sealant composition.

24. The method of embodiment 22 or 23, wherein the surface is a hard surface, and optionally wherein the surface is a surface of a vehicle.

25. The method of any one of embodiments 22-24, wherein the method further comprises applying the sealant composition to an applicator and using the applicator to apply the sealant composition to the surface; and optionally wherein the applicator is a polyurethane sponge.

26. A kit comprising the polishing composition of any one of embodiments 1-7 and the sealant composition of any one of embodiments 13-20 and one or more applicators for applying the polishing composition and/or the sealant composition.

27. The kit of embodiment 26, wherein the applicator for applying the polishing composition and/or the sealant composition is a mechanical device.

28. A method of polishing and sealing a surface, wherein the method comprises:
cleaning and polishing a surface with the polishing composition of any one of embodiments 1-7 or the kit of embodiment 26 or 27; and
sealing the cleaned and polished surface with the sealant composition of any one of embodiments 13-20 or the kit of embodiment 26 or 27.

29. The method of embodiment 28, wherein the surface is a glass surface that is not coated.

30. The method of embodiment 28 or 29, wherein the surface is a vehicular surface, and optionally the vehicular surface comprises windshield, window, sunroof, moonroof, interior mirror, and exterior mirror.

31. The method of any one of embodiments 28-30, wherein the method further comprises: applying the polishing composition to an applicator and using the applicator to apply the polishing composition to the surface, and optionally wherein the applicator is a mechanical device; and/or applying the sealant composition to an applicator and using the applicator to apply the sealant composition to the surface, and optionally wherein the applicator is a polyurethane sponge.

### EXAMPLES

Representative embodiments of the present disclosure will now be described with reference to the following examples that illustrate the principles and practices of the present disclosure.

Windshield polishing agent compositions were prepared as shown in Examples 1 and 2 below.

Windshield sealant compositions were prepared as shown in Examples 3 and 4 below.

TABLE E1

| | | Component |
|---|---|---|
| Component | Function | Quantity |
| DI Water | Solvent | 91.9 |
| Cerium Oxide (Powder) D50 5-10 um | Abrasive | 5.00 |
| Carboxymethyl Cellulose (n-500) | Suspending agent | 3.00 |
| TROYGUARD ™ BC-11 | Preservative | 0.1 |
| Total | | 100.00 |

The composition was prepared by combining the components sequentially with constant mixing. For example, sequentially adding the water, one or more suspending agents, and cerium oxide. The composition may also be prepared wherein one or more preservatives are added to the water before the one or more suspending agents.

### Example 2

TABLE E2

| | | Component |
|---|---|---|
| Component | Function | Quantity |
| DI Water | Solvent | 90.0-95.0 |
| Cerium Oxide (Powder) D50 5-10 um | Abrasive | 4.5-5.5 |
| Carboxymethyl Cellulose (n-500) | Suspending agent | 2.5-3.50 |
| benzisothiazolinone | Preservative | 0.01-0.1 |
| Total | | 100.00 |

The composition was prepared as described in Example 1.

### Example 3

TABLE E3

| | | Component |
|---|---|---|
| Component | Function | Quantity |
| DOWSIL ™ 2405 Resin | Film Forming Resin, binder | 35.00 |
| XIAMETER ™ OFX 536 | Additive for | 5.00 |
| Fluid | Hydrophobicity | |
| ISOPAR ™ M Fluid | Organic Solvent | 40.00 |
| Odorless mineral spirits | Co-Solvent | 20.00 |
| Total | | 100.00 |

The composition was prepared by combining all the components and then mixing the components. The components can be combined sequentially or all at the same time and then mixed.

### Example 4

TABLE E4

| | | Component |
|---|---|---|
| Component | Function | Quantity |
| dimethyl siloxane with Me | Film Forming | 34.5-35.5 |
| silsesquioxanes and n-octyl | Resin, binder | |
| silsesquioxanes, methoxy-term | | |
| dimethyl siloxane, OH-term Rxn | Additive for | 4.5-5.5 |
| methyltrimethoxysilane, and | Hydrophobicity | |
| aminoethylaminopropyltrimethoxysilane | | |
| C13-C14 isoparaffins | Organic Solvent | 35.0-45.0 |
| Odorless mineral spirits | Co-Solvent | 15.0-25.0 |
| Total | | 100.00 |

The composition was prepared as described in Example 3.

1. A polishing composition, wherein the polishing composition comprises cerium oxide, one or more suspending agents, and water, and optionally one or more preservatives.

2. The polishing composition of claim 1, wherein the cerium oxide is in powdered form, and optionally the cerium oxide has a particle size of 1 to 20 microns and/or a purity of about 95% to 100%.

3. The polishing composition of claim 1, wherein the one or more suspending agents comprise carboxymethyl cellulose, hydroxypropyl methyl cellulose, a modified acrylic polymer, an acrylic copolymer, or a combination thereof.

4. The polishing composition of claim 1, wherein the one or more preservatives comprise hydantoin germicide, carbamate fungicide, benzisothiazolinone (BIT), methylisothiazolinone (MIT), and/or methylchloroisothiazolinone (CMIT); and optionally the one or more preservatives comprise a combination of BIT, MIT, and CMIT.

5. The polishing composition of claim 1, wherein the polishing composition comprises by total weight of the composition:
about 85.0% to 95.0% water;
about 0.5% to 5% cerium oxide; and
about 0.5% to 5% of one or more suspending agents; and
optionally about 0.05% to 0.50% of one or more preservatives.

6. The polishing composition of claim 1, wherein the polishing composition comprises cerium oxide, carboxymethyl cellulose, benzisothiazolinone, and deionized water.

7. The polishing composition of claim 1, wherein the polishing composition comprises by total weight of the composition:
about 91.9% deionized water;
about 5% cerium oxide having a particle size of 5 to 10 microns;
about 3.0% carboxymethyl cellulose; and
about 0.10% benzisothiazolinone.

8. A method of preparing the composition of claim 1, wherein the method comprises combining sequentially with constant mixing: water, one or more suspending agents, and cerium oxide; and optionally wherein one or more preservatives are added to the water before the one or more suspending agents.

9. A method of polishing a surface, wherein the method comprises applying the polishing composition of claim 1 to a surface to remove contaminants and scratches.

10. The method of claim 9, wherein the surface is a glass surface that is not coated.

11. The method of claim 9, wherein the surface is the surface of a vehicle, and optionally the surface comprises a windshield, a window, an exterior glass, an interior mirror, and an exterior mirror.

12. The method of claim 9, wherein the method further comprises applying the polishing composition to an applicator and using the applicator to apply the polishing composition to the surface; and optionally wherein the applicator is a mechanical device.

13. A sealant composition, wherein the sealant composition comprises:
two or more dimethyl siloxanes, wherein the two or more dimethyl siloxanes comprise one or more alkoxy siloxane resins and one or more dimethyl siloxane fluids; and one or more hydrocarbons.

14. The sealant composition of claim 13, wherein the one or more alkoxy siloxane resins comprise a solvent-less methoxy functional liquid siloxane, and optionally wherein the one or more alkoxy siloxane resins comprise dimethyl siloxane with Me silsesquioxanes and n-octyl silsesquioxanes, methoxy-term.

15. The sealant composition of claim 13, wherein the one or more dimethyl siloxane fluids comprise dimethyl siloxane, OH-term Rxn methyltrimethoxysilane, and aminoethylaminopropyltrimethoxysilane.

16. The sealant composition of claim 13, wherein the one or more hydrocarbons comprise isoparaffins and mineral spirits.

17. The sealant composition of claim 13, wherein the one or more hydrocarbons comprise C13-C14 isoparaffins and odorless mineral spirits.

18. The sealant composition of claim 13, wherein the sealant composition comprises by total weight of the composition:
about 30.0% to 50.0% of one or more alkoxy siloxane resins;
about 1.0% to 10.0% of one or more dimethyl siloxane fluids;
about 30.0% to 50.0% of one or more isoparaffins; and
about 10.0% to 30.0% of one or more mineral spirits.

19. The sealant composition of claim 13, wherein the sealant composition comprises dimethyl siloxane with Me silsesquioxanes and n-octyl silsesquioxanes, methoxy-term; dimethyl siloxane, OH-term Rxn methyltrimethoxysilane and aminoethylaminopropyltrimethoxysilane; C13-C14 isoparaffins; and odorless mineral spirit.

20. The sealant composition of claim 13, wherein the sealant composition comprises by total weight of the composition:
about 35.0% dimethyl siloxane with Me silsesquioxanes and n-octyl silsesquioxanes, methoxy-term; methoxy-term;
about 5.0% dimethyl siloxane, OH-term Rxn methyltrimethoxysilane and aminoethylaminopropyltrimethoxysilane;
about 40.0% C13-C14 isoparaffins; and
about 20% odorless mineral spirit.

21. A method of preparing the composition of claim 13, wherein the method comprises:
combining two or more dimethyl siloxanes, wherein the two or more dimethyl siloxanes comprise one or more alkoxy siloxane resins and one or more dimethyl siloxane fluids; and
one or more hydrocarbons; and
mixing the composition.

22. A method of sealing a surface, wherein the method comprises applying the sealant composition of claim 13 to a surface; and optionally, wherein the surface has been polished and/or cleaned before applying the sealant composition.

23. The method of claim 22, wherein the surface is a hard surface, and optionally wherein the surface is a surface of a vehicle.

24. A kit comprising a polishing composition and a sealant composition, wherein the polishing composition comprises cerium oxide, one or more suspending agents, and water, and optionally one or more preservatives, and wherein the sealant composition comprises two or more dimethyl siloxanes, the two or more dimethyl siloxanes comprising one or more alkoxy siloxane resins and one or more dimethyl siloxane fluids; and one or more hydrocarbons.
